(19) United States
(12) Patent Application Publication
(10) Pub. No.: US 2025/0026434 A1
(43) Pub. Date: Jan. 23, 2025

(54) SWINGARM STABILIZER DEVICE

(71) Applicant: Colby Gerald Richard Therrien, Kamloops (CA)

(72) Inventor: Colby Gerald Richard Therrien, Kamloops (CA)

(21) Appl. No.: 18/353,934

(22) Filed: Jul. 18, 2023

(51) Int. Cl. B62K 25/28

(52) U.S. Cl. CPC B62K 25/283

(57) ABSTRACT

A swingarm stabilizer that is configured to be mounted onto a swingarm wherein the present invention is operable to inhibit any lateral movement of the swingarm. The present invention includes a body wherein the body is comprised of a first portion and a second portion that are contiguously formed. The first portion has a diameter that is greater than the diameter of the second portion. The first portion has a first passage extending therethrough with an opening at the first end of the body. The first passage is contiguous with the second passage wherein the second passage extends through the second portion of the body having an opening at the second end of the body. The first passage is cylindrical in shape while the second passage is hexagonal in shape. The first passage has a diameter that is less than the diameter of the second passage.

### FIELD OF THE INVENTION

The present invention relates generally to motorcycle accessories, more specifically but not by way of limitation, a swingarm stabilizer designed to be operably coupled to a swingarm of a motorcycle wherein the present invention inhibits undesirable movement of the swingarm during use of a motorcycle.

### BACKGROUND

As is known in the art, motorcycles employ a swingarm to operably couple the rear wheel to the frame of the motorcycle. Most motorcycle swingarms have two arm members that are located on opposing sides of the wheel and tire assembly of the motorcycle. Single sided swingarms are also produced and utilized on various styles of motorcycles. The swingarm is the main component of the rear suspension of most modern motorbikes and is operable to hold the rear axle to the frame, while further being able to pivot so as to absorb bumps and suspension loads induced by the rider during events such as but not limited to acceleration and braking.

While conventional swingarms accomplish their intended purpose, there are known problems with certain brands and types of motorcycles as it pertains to the performance of the swingarm. Manufacturing tolerances require a certain amount of space for mechanical elements such as pivot shafts in order to facilitate assembly during production of the motorcycle. The swingarm of a motorcycle is typically secured to the frame with a long shaft that extends from one side of the swingarm attachment point to the opposing side. One particular brand of motorcycle has larger tolerances on the transmission bore which the pivot shaft of the swingarm is operably coupled thereto. The result is a swingarm assembly that has unwanted lateral movement which creates instability for the rider of the motorcycle, especially during cornering maneuvers.

Accordingly, there is a need for a swingarm stabilizing device that can be operably coupled to the swingarm of a motorcycle wherein the present invention inhibits lateral movement of the swingarm.

### SUMMARY OF THE INVENTION

It is the object of the present invention to provide a swingarm stabilizing device that is configured to be operably coupled to a motorcycle swingarm wherein the present invention includes a body that is cylindrical in shape having a first portion and second portion.

Another object of the present invention is to provide a stabilizer for a motorcycle swingarm wherein the body has a first end and a second end.

A further object of the present invention is to provide a swingarm stabilizing device that is configured to be operably coupled to a motorcycle swingarm wherein the first portion has a diameter that is greater than the diameter of the second portion.

Yet a further object of the present invention is to provide a stabilizer for a motorcycle swingarm wherein the body includes an opening at the second end providing access to a passage wherein the passage is hollow and has a hexagonal shape.

Still another object of the present invention is to provide a swingarm stabilizing device that is configured to be operably coupled to a motorcycle swingarm wherein the hollow passage extends through the first portion and second portion of the body and further having an opening at the first end of the body.

An additional object of the present invention is to provide a stabilizer for a motorcycle swingarm wherein the passage in the first portion of the body has a diameter that is less than the diameter of the passage extending through the second portion of the body.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective end view of the present invention with dotted lines showing the internal passage; and

FIG. 2 is an exploded parts view of a conventional swingarm; and

FIG. 3 is a perspective view of the present invention; and

FIG. 4 is an end view from the second end of the body of the present invention; and

FIG. 5 is a cross-sectional of the present invention.

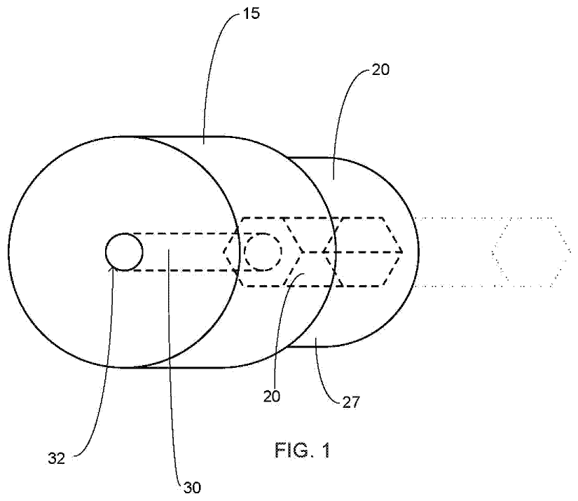

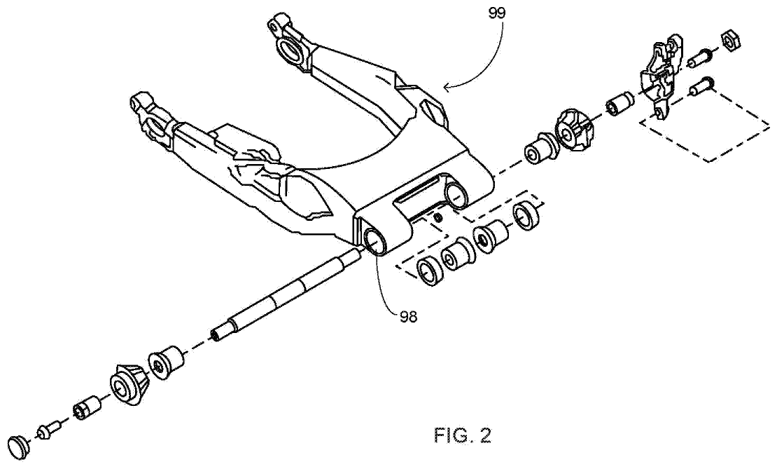

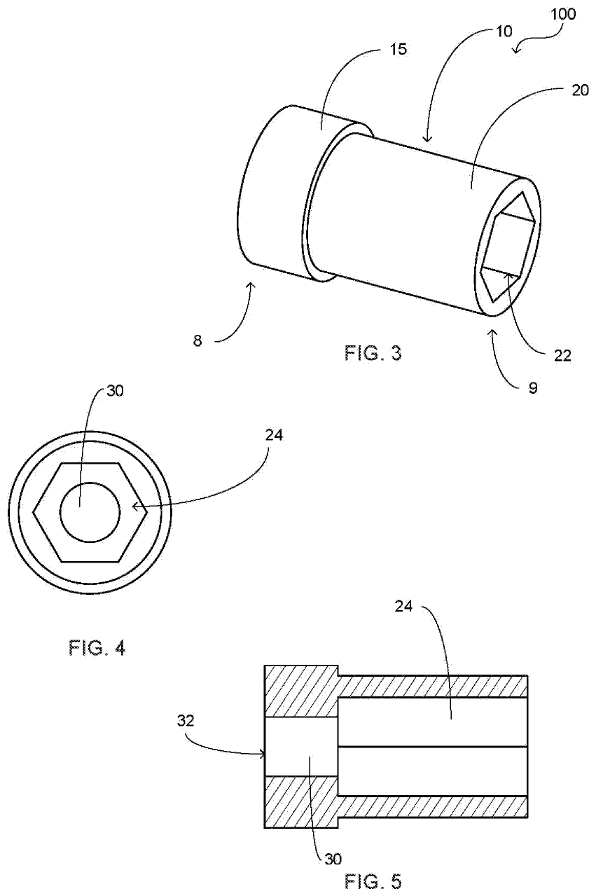

### DETAILED DESCRIPTION

Referring now to the drawings submitted herewith, wherein various elements depicted therein are not necessarily drawn to scale and wherein through the views and figures like elements are referenced with identical reference numerals, there is illustrated a swingarm stabilizer 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the swingarm stabilizer 100 is manufactured from a durable rigid material such as but not limited to nylon. It should be understood within the scope of the present invention that the swingarm stabilizer 100 could be manufactured in alternate sizes so as to be operably coupled to different brands and types of motorcycles. The swingarm stabilizer 100 includes a body 10 wherein the body 10 includes a first end 8 and a second end 9. The body 10 is cylindrical in shape and is comprised of a first portion 15 and a second portion 20 that are contiguously formed. The first portion 15 is proximate the first end 8 and has a diameter that is greater than the diameter of the second portion 20. The second portion 20 is manufactured of a suitable diameter to be inserted into aperture 98 of exemplary swingarm assembly 99. It should be understood within the scope of the present invention that the second portion 20 could be provided in alternate diameters in order to be mateable with different brands of swingarm assemblies. Furthermore, it should be understood within the scope of the present invention that the second portion 20 can be manufactured in alternate lengths.

The second portion 20 includes opening 22 that provides access to the second passage 24. The second passage 24 is hexagonal in shape so as to be journaled over a conventional nut that is utilized to secure the swingarm bolt. It should be understood within the scope of the present invention that the second passage 24 could be provided in alternate sizes so as to accommodate different sizes of nuts therein. The second passage 24 extends the length of the second portion 20 of the body 10 and is operably coupled the first passage 30. The first passage 30 is contiguous with the second passage 24 having a diameter that is less than that of the second passage 24.

The first passage 30 is cylindrical in shape so as to mateably accommodate therethrough a conventional bolt that is utilized to secure a swingarm assembly 99. The first passage 30 has an opening 32 proximate the first end 8 of the body 10. The first passage 30 extends the length of the first portion 15 of the body 10. It should be understood within the scope of the present invention that the body 10 could be manufactured in various lengths as needed for alternate types of swingarm assemblies. Additionally, while the preferred embodiment of the first passage 30 is cylindrical, the first passage 30 could be provided in alternate shapes so as to mateably accommodate a bolt or shaft utilized on a swingarm assembly of a different shape.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A swingarm stabilizer that is operable to inhibit lateral motion of a swingarm on a motorcycle wherein the swingarm stabilizer comprises:
a body, said body having a first end and a second end, said body being cylindrical in shape, said body having a first portion and a second portion, said first portion and said second portion of said body being contiguous, said first portion of said body having a diameter that is greater than a diameter of the second portion, said body having a first opening proximate said first end, said body having a second opening proximate said second end;
a first passage, said first passage extending through said first portion of said body from said first opening;
a second passage, said second passage extending through said second portion of said body from said second opening, said second passage being contiguous with said first passage; and
wherein said second passage has a diameter that is greater than a diameter of the first passage.

2. The swingarm stabilizer that is operable to inhibit lateral motion of a swingarm on a motorcycle as recited in claim 1, wherein said second portion of said body has a length that is greater than a length of the first portion of the body.

3. The swingarm stabilizer that is operable to inhibit lateral motion of a swingarm on a motorcycle as recited in claim 2, wherein the first passage is cylindrical in shape.

4. The swingarm stabilizer that is operable to inhibit lateral motion of a swingarm on a motorcycle as recited in claim 3, wherein the second passage is hexagonal in shape.

5. The swingarm stabilizer that is operable to inhibit lateral motion of a swingarm on a motorcycle as recited in claim 4, wherein said body is manufactured from nylon.
